(19) United States
(12) Patent Application Publication
(10) Pub. No.: US 2009/0083477 A1
(43) Pub. Date: Mar. 26, 2009

(54) METHOD AND APPARATUS FOR FORMATTING PORTABLE STORAGE DEVICE

(75) Inventors: Tae-hun Lee, Suwon-si (KR); Hee-chul Yun, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/030,409

(22) Filed: Feb. 13, 2008

(30) Foreign Application Priority Data
Sep. 21, 2007 (KR) 2007-96944

(51) Int. Cl. G06F 12/00; G06F 12/02; G06F 12/06

(52) U.S. Cl. 711/103; 711/171; 711/166; 711/E12.001; 711/E12.008; 711/E12.084

(57) ABSTRACT

A method and apparatus for formatting a portable storage device, which are capable of performing formatting optimized for a non-volatile memory of the portable storage device. The method includes: detecting whether file system information is initialized when formatting of the non-volatile memory is started; if the initialization of the non-volatile memory is detected, detecting a cluster size and cluster start position of a storage space of the portable storage device; and if the detected cluster size and the cluster start position information do not match a size and a staring position of a minimum recording unit of the storage space, performing a re-formatting operation of the portable storage device.

### CROSS-REFERENCE TO RELATED APPLICATION

This application claims the benefit of Korean Application No. 2007-96944, filed Sep. 21, 2007 in the Korean Intellectual Property Office, the disclosure of which is incorporated herein by reference.

### BACKGROUND OF THE INVENTION

1. Field of the Invention

Aspects of the present invention relate to a method and apparatus for formatting a portable storage device, and more particularly, to a method and apparatus for performing optimized formatting of a non-volatile memory in the portable storage device.

2. Description of the Related Art

Electrically erasable non-volatile memory, such as NAND flash memory, is widely used in many electronic devices. For example, a portable storage device includes NAND flash memory to store various types of digital data such as still image data, moving image data, audio data, and the like. Such portable storage device can be an mp3 player, a portable multimedia player (PMP), and the like.

The portable storage device generally uses a file application table (FAT) system to store files in the non-volatile memory. That is, the non-volatile memory includes a FAT region and a data region. The FAT region is a table for recording addresses of the data region. Several sectors included in the data region are allocated as clusters, and the clusters are stored in addresses of 12 bits, 16 bits, 32 bits, etc.

The non-volatile memory of the portable storage device is typically formatted by using an external device, such as a personal computer (PC). However, formatting methods differ according to various operating systems (OS) of the PC, so that a data transmission rate of the portable storage device may differ and decrease based on the used OS environment.

The non-volatile memory uses (or records) a minimum unit of writing for each time a recording operation is performed. Therefore, the portable storage device using the non-volatile memory has several problems discussed below according to a cluster size and a start sector point (or position) of a cluster, which are determined or set when a file system (such as the FAT system) is formatted. Here, the cluster is a unit of access for a storage medium (such as the non-volatile memory).

First, when the non-volatile memory is formatted to have a cluster size that is smaller than a minimum writing unit size, a number of writings occurs, which causes performance degradation. For example, if the minimum writing unit size of the non-volatile memory is 4 kilobytes (KB) and the cluster size thereof is 1 KB, writing (or recording) operations are as illustrated in FIGS. 1A to 1C.

Given three clusters (a total of 3 KB) that are written to the non-volatile memory as illustrated in FIG. 1A, a writing operation is performed if two clusters are additionally written to the non-volatile memory. Namely, a 3 KB reading operation, a 4 KB writing operation, and a 1 KB writing operation have to be sequentially performed, as illustrated in FIG. 1B. Further, a 4 KB garbage region has to be deleted, as illustrated in FIG. 1C.

In addition, if the start sector point (or position) of the clusters is not aligned with the minimum writing unit size of the non-volatile memory, a number of writings occurs, which causes performance degradation. As illustrated in FIG. 1D, when a size (or a size of a writing or a recording) of the non-volatile memory is 4 KB and the cluster size is 4 KB, the minimum writing unit size of the non-volatile memory and the cluster size are equal. However, since the start sector point (or position) of the clusters is not aligned with the minimum writing unit size, a number of writing operations occurs, such as the 3 KB writing operation, the 4 KB writing operation, and the 1 KB writing operation. Here, to align refers to re-arranging position information to fit a minimum unit of storage of a storage space of the non-volatile memory.

Therefore, the typical formatting method according to the OS of the PC increases a work load for storing data, so that a problem of decreased data transmission rate occurs.

### SUMMARY OF THE INVENTION

Aspects of the present invention provide a method and apparatus for formatting a portable storage device, which are capable of improving a file transmission rate by performing optimized formatting of a storage medium of the portable storage device using a personal computer (PC).

According to an aspect of the present invention, there is provided a method of formatting a portable storage device, including: detecting whether file system information of the portable storage device is initialized when a formatting operation of the portable storage device is started; if an initialized state of the file system information is detected, detecting cluster size information and cluster start position information of a storage space of the portable storage device; and if the detected cluster size and the cluster start position do not match a size and a position of a minimum recording unit of the storage space, performing a re-formatting operation of the portable storage device.

According to another aspect of the present invention, there is provided a portable storage device including: a universal serial bus (USB) device to transmit and receive data and a control command to and from an external device connected to the portable storage device according to a predetermined interface standard; a memory unit to store content files in a predetermined file system structure; and a controller to detect cluster size information and cluster start position information of a data storage sector recorded in a boot record sector of the memory unit when a formatting operation is performed on the portable storage device according to a command received via the USB device, and performing a re-formatting operation on the portable storage device when the detected cluster size and the cluster start position information do not match a size and a position of a minimum recording unit of the data storage sector.

According to another aspect of the present invention, a method of formatting a non-volatile memory of a portable storage device includes determining whether a cluster size and a minimum recording size of the non-volatile memory are different; selectively determining whether a start position of a cluster and a start position of the minimum recording size are aligned, if the cluster size and the minimum recording size are different; and performing a formatting operation of the non-volatile memory if either the cluster size and the minimum recording size are different or the start position of the cluster and the start position of the minimum recording size are not aligned.

According to another aspect of the present invention, a portable storage device, includes a non-volatile memory to store data; and a controller to, determine whether a cluster size and a minimum recording size of the non-volatile memory are different, selectively determine whether a start position of a cluster and a start position of the minimum recording size are aligned, if the cluster size and the minimum recording size are different, and perform a formatting operation of the non-volatile memory if either the cluster size and the minimum recording size are different or the start position of the cluster and the start position of the minimum recording size are not aligned.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIGS. 1A to 1D are views for explaining writing operations performed according to a cluster size and a start sector point thereof that is determined when a file system is formatted in a typical portable storage device;

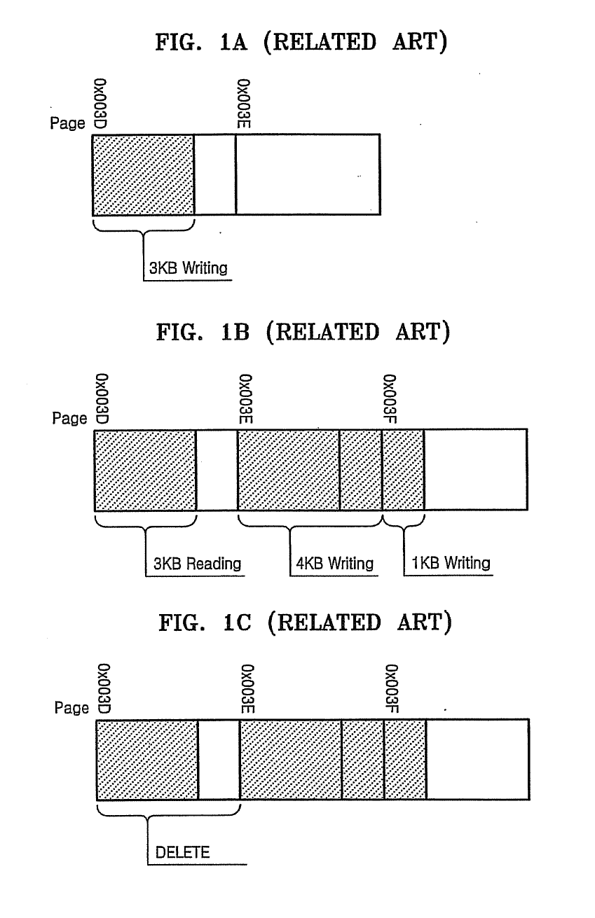

FIG. 2 illustrates a structure of a file allocation table (FAT) file system for a portable storage device according to an aspect of the present invention;

FIG. 3 illustrates a representation of a FAT1 illustrated in FIG. 2, according to an aspect of the present invention;

FIG. 4 illustrates a system for formatting a portable storage device according to an aspect of the present invention; and

FIG. 5 is a flowchart of a method of formatting a portable storage device according to an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

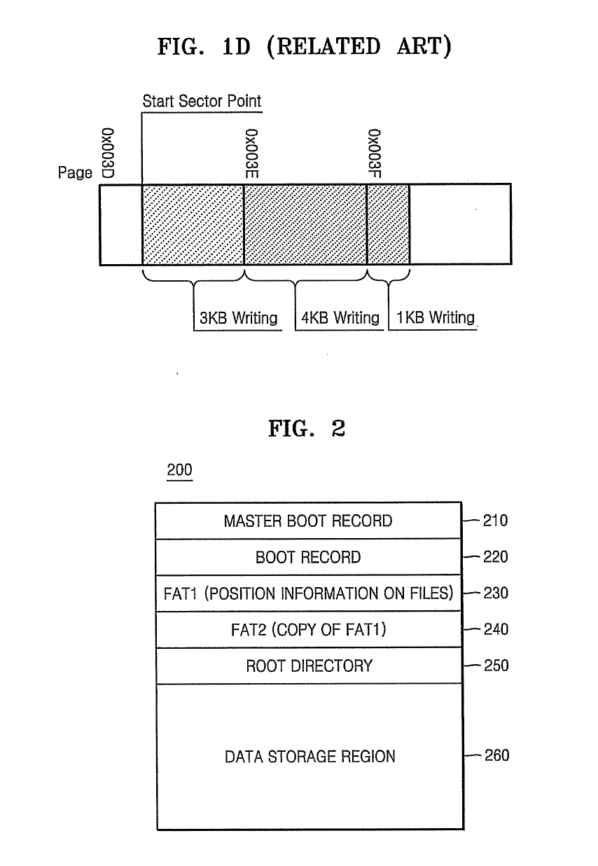

FIG. 2 illustrates a structure of a file allocation table (FAT) file system for a portable storage device according to an aspect of the present invention. The FAT file system may be a FAT12, a FAT16, a FAT32, a VFAT (virtual FAT), and so on.

The FAT12 may have 2¹² sectors and a maximum capacity of about 2 MB. When 8 sectors are defined as a minimum storage space, for example, a minimum writing (or recording) unit, the FAT12 can have a maximum storage capacity of about 16 MB. The FAT16 may have 2¹⁶ sectors and provides about 30 MB of maximum storage capacity as a single partition. If 64 sectors are defined as a cluster, an area of about 2 GB can be used as a single partition. The FAT32 may have 2³² sectors, so that even if a sector is defined as a cluster, a partition of about 2 TB can be used. Finally, the VFAT (virtual FAT) is a file system for supporting a long file name.

Referring to FIG. 2, the FAT file system 200 includes a master boot record sector (or region) 210, a boot record sector (or region) 220, FAT 230 and 240, a root directory sector (or region) 250, and a data storage sector (or region) 260. The FAT includes FAT1 230 and FAT2 240. The FAT1 230 stores position information of files and is used to retrieve data by an operating system (OS). The FAT2 240 is a copy of the FAT1 230.

When the position information recorded in the FAT1 230 is damaged, a file at a corresponding position cannot be found although information of the file stored in the data storage sector 260 is not damaged. Therefore, the FAT2 240 as a copy of the FAT1 is maintained, and when files are recorded or deleted on or from a the data storage sector 260, for example, the position information recorded in the FAT1 230 is changed according to the recording or deleting of the file, for example, and at the same time, the same change is made to the FAT2 240.

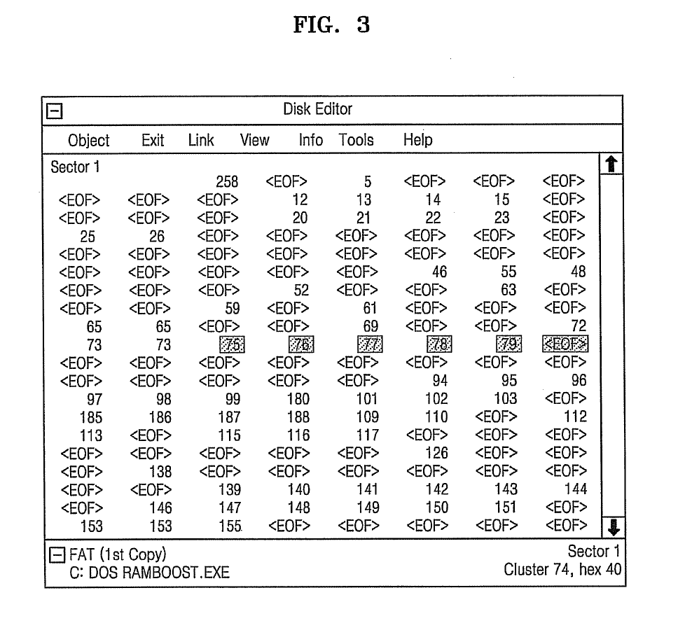

FIG. 3 illustrates a representation of the FAT1 230 illustrated in FIG. 2, according to an aspect of the present invention. Black regions 75 to <EOF> are occupied by 74-th to 79-th clusters. The 79-th cluster is displayed as <EOF>, which refers to the last cluster of a file. In the FAT region 230, 240, such as FAT1 230, only a range of a cluster in which a file is positioned is displayed, and a name of the file that is occupying the cluster is not known.

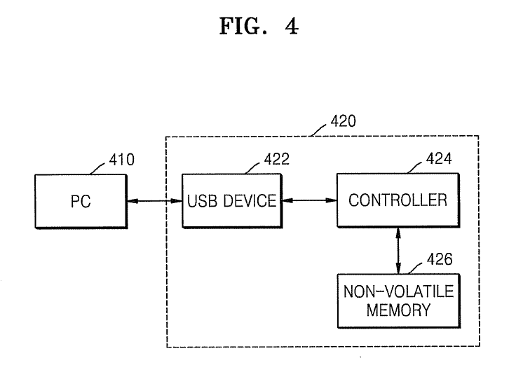

FIG. 4 illustrates a system for formatting a portable storage device according to an aspect of the present invention. Referring to FIG. 4, a personal computer (PC) 410 is connected to a portable storage device 420 via a universal serial bus (USB), for example. The PC 410 transmits a read/write command to format a non-volatile memory 426 according to the PC's OS system to the portable storage device 420. An external control device instead of the PC 410 may be connected to the portable storage device 420 to provide the read/write command. In other aspects, an internal OS or a formatting program may be embedded in the portable storage device 420 to provide the read/write command to initiate a formatting operation. Also, the portable storage device 420 may be connected to the PC 410 via other connections, including wired connections, or wireless connections.

The portable storage device 420 formats the non-volatile memory 426 of the portable storage device 420 according to the read/write command received from the PC 410 through a predetermined interface standard. If the formatting operation performed by the portable storage device 420 is not proper for the non-volatile memory 426, the portable storage device 420 delays (or suspends) communication with the PC 410 so that a re-formatting operation that is proper for the non-volatile memory 426 is performed. Thereafter, the communication with the PC 410 is resumed. In various aspects, a proper formatting operation may refer to one that aligns a cluster (or a start point (or position) thereof with a minimum writing unit of the non-volatile memory 426, and an improper format operation may refer to one that does not align the cluster (or a start point (or position) thereof) with the minimum writing unit of the non-volatile memory 426.

The formatting operation involves two different processes referred to as a low-level formatting operation and a high-level formatting operation. The high-level formatting operation is performed to initialize a device so as to enable a user to use the OS. The low-level formatting operation is performed to initialize a device to a factory preformatted state. When the high-level formatting operation is determined as the type of a formatting operation to be used for a user environment, the high-level formatting operation is performed as follows.

1) All information of the FAT is changed to “0” (e.g., an initial state or an initialized state); and

2) A first letter of a corresponding file name of a root directory is changed to a small letter sigma (σ).

Returning to FIG. 4, the portable storage device 420 will be described in detail. The portable storage device 420 includes a USB device 422, a controller 424, and the non-volatile memory 426, for example. The USB device 422 transmits data to the PC 410 by way of a USB standard and receives a control command and data from the PC 410. The non-volatile memory 426 has the file system structure illustrated in FIG. 2 and stores content files, such as still image data, moving image data, audio data, and the like.

The controller 424 transmits and/or receives the control command and the data to and/or from the PC 410 through the USB device 422. When the formatting operation is started by the read/write command received from the PC 410, it is detected whether the file system information on the non-volatile memory 426 is initialized. If the initialization (or the initialized state of the file system) is detected, a cluster size and start position information of the data storage sector recorded in the boot record sector of the non-volatile memory 426 are detected, and if the detected cluster size and the start position information do not match a size of a minimum recording unit (or a minimum writing unit), a re-formatting operation is performed. In addition, the controller 424 delays (or suspends) communication with the PC 410 by transmitting a negative-acknowledgment (NACK) signal to the PC 410 while performing the re-formatting operation, and when the re-formatting operation is completed, the controller 424 transmits an ACK (acknowledgement) signal to the PC 410 to resume the communication with the PC 410.

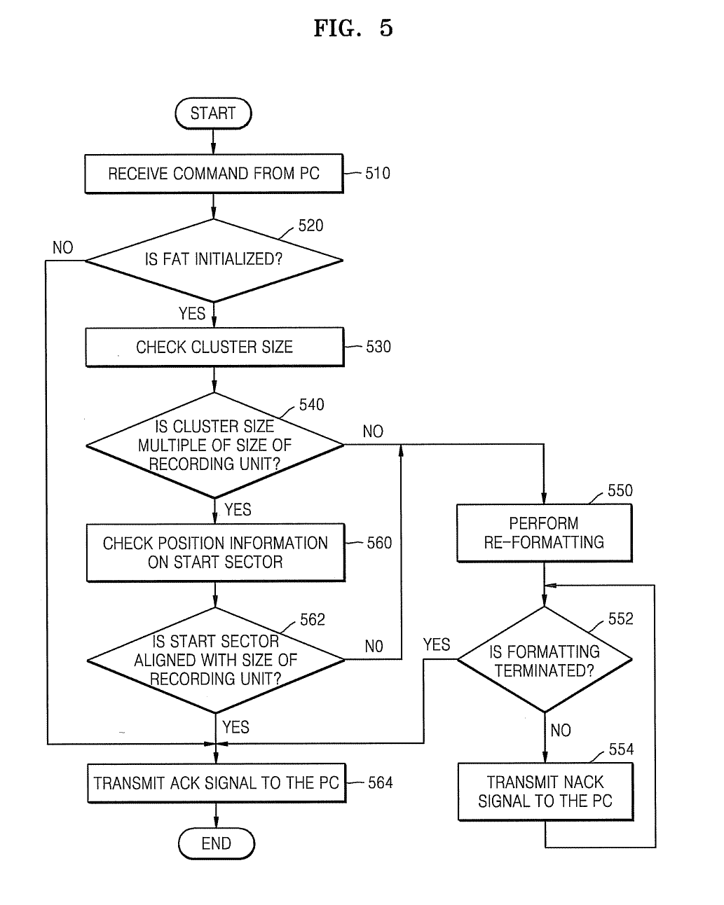

FIG. 5 is a flowchart of a method of formatting a portable storage device according to an aspect of the present invention. First, a read/write command for a formatting operation is received from the PC 410 (operation 510). Next, when the formatting operation is started by the read/write command received from the PC 410, it is checked whether the FAT file system is initialized (operation 520). For example, it is detected (or determined) whether all of the information in the FAT is deleted (or initialized) by the read/write command received from the PC 410.

Next, if the initialization of the FAT is detected (or if the FAT is detected to be initialized), the cluster size of the data storage sector recorded in the boot record sector is checked (operation 530). Next, it is checked whether the cluster size is a multiple of the size of the minimum recording unit of the data storage sector (operation 540). Here, if the cluster size is not a multiple of the size of the minimum recording unit of the data storage sector, the re-formatting operation is performed to place the non-volatile memory in a proper format by using an internal program or the OS (operation 550). However, if the cluster size is the multiple of the size of the minimum recording unit of the data storage sector, position information of a start sector of the cluster recorded in the boot record sector is checked (operation 560).

Next, it is checked whether the position address of the start sector of the cluster is aligned on (or with) a recording start point (or position) of a memory region (or a recorded region) corresponding to the size of the minimum recording unit (operation 562). Here, if the position address of the start sector of the cluster is not aligned on (or with) the recording start point (or position) of the memory region (or a recorded region) corresponding to the size of the minimum recording unit, the re-formatting operation is performed to place the non-volatile memory in proper format by using the internal program or the OS (operation 550).

However, when the position address on the start sector of the cluster is aligned on (or with) the recording start point of the memory region (or a recorded region) corresponding to the size of the minimum recording unit, an ACK signal (an acknowledgement signal) is transmitted to the PC 410. Then, it is checked whether the re-formatting operation is terminated (operation 552). Here, if the re-formatting operation is not terminated, a NACK signal (a negative-acknowledgement signal) is transmitted to the PC 410. When the re-formatting operation is terminated, the ACK signal is transmitted to the PC 410 to terminate the formatting (or the re-formatting) operation. Therefore, when a formatting operation that is not proper for the non-volatile memory is performed, communication with the PC 410 is delayed (or suspended) and the re-formatting operation is performed.

Accordingly, changes in the performance of the portable storage device using the non-volatile memory arising from use of various operating systems (OS) are minimized, so that a data transmission rate of the portable storage device can be (or guaranteed to be) higher than a predetermined level.

In addition, the number of the writing operations of the non-volatile memory is minimized, so that the life span of the portable storage device can be increased.

In various aspects, the term check or checked may also refer to detecting, detecting, or obtaining information or data.

In various aspects, the portable storage device includes flash memory cards, hard discs, and optical discs.

In various aspects, the non-volatile memory is NAND flash memory.

Aspects of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. Also, aspects of the invention may also be embodied in computer-readable code embodied as a computer data signal in a carrier wave (such as data transmission through the Internet). The computer readable recording medium can also be distributed over network coupled computer systems so that the computer readable code is stored and executed in a distributed fashion.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A method of formatting a portable storage device, comprising:
detecting whether file system information of the portable storage device is initialized when a formatting operation of the portable storage device is started;
if an initialized state of the file system information is detected, detecting cluster size information and cluster start position information of a storage space of the portable storage device; and
if the detected cluster size and the cluster start position do not match a size and a position of a minimum recording unit of the storage space, performing a re-formatting operation of the portable storage device.

2. The method of claim 1, further comprising delaying communication with a device connected to the portable storage device when the detected cluster size and the cluster start position do not match the size and the position of the minimum recording unit.

3. The method of claim 2, wherein the delaying of the communication with the device connected to the portable storage device comprises:
checking whether the re-formatting operation is terminated; and
transmitting a negative-acknowledgement signal to the device if the re-formatting operation is not terminated, and transmitting an acknowledgement signal to the device if the re-formatting operation is terminated.

4. The method of claim 1, wherein the minimum recording unit is a recording unit of a non-volatile memory included in the portable storage device.

5. The method of claim 1, wherein the performing of the re-formatting operation comprises performing the re-formatting by using an internal program if the detected cluster size is not a multiple of the size of the minimum recording unit, or the cluster start position is not aligned on a start position of a region corresponding to the position of the minimum recording unit.

6. The method of claim 1, wherein the performing of the re-formatting operation comprises performing a re-formatting operation that aligns the cluster start position with a start position of minimum recording unit of a non-volatile memory in the portable storage device.

7. A portable storage device comprising:
a USB (universal serial bus) device to transmit and receive data and a control command to and from an external device that is connected to the portable storage device according to a predetermined interface standard;
a memory unit to store content files in a predetermined file system structure; and
a controller to detect cluster size information and cluster start position information of a data storage sector recorded in a boot record sector of the memory unit when a formatting operation is performed on the portable storage device according to a command received via the USB device, and performing a re-formatting operation on the portable storage device when the detected cluster size and the cluster start position information do not match a size and a position of a minimum recording unit of the data storage sector.

8. The portable storage device of claim 7, wherein the memory unit is a non-volatile memory.

9. The portable storage device of claim 7, wherein the controller transmits a negative-acknowledgement signal to the external device while the re-formatting operation is performed and transmits an acknowledgement signal to the external device when the re-formatting operation is completed.

10. A computer-readable medium having embodied thereon a computer program to execute a method of formatting a portable storage device, wherein the method comprises:
detecting whether file system information is initialized when a formatting operation of the portable storage device is started;
if an initialized state of the file system information is detected, detecting cluster size information and cluster start position information of a storage space of the portable storage device; and
if the detected cluster size and the cluster start position information do not match a size and position of a minimum recording unit of the storage space, performing a re-formatting operation of the portable storage device.

11. A method of formatting a non-volatile memory of a portable storage device, comprising:
determining whether a cluster size and a minimum recording size of the non-volatile memory are different;
selectively determining whether a start position of a cluster and a start position of the minimum recording size are aligned, if the cluster size and the minimum recording size are different; and
performing a formatting operation of the non-volatile memory if either the cluster size and the minimum recording size are different or the start position of the cluster and the start position of the minimum recording size are not aligned.

12. The method of claim 11, wherein the performing of the formatting operation of the non-volatile memory comprises:
changing all information of a file application table (FAT) of the non-volatile memory to 0, which is an initial state; and
changing a first letter of a corresponding file name of a root directory of the FAT to a small letter sigma (σ).

13. The method of claim 11, wherein the determining of whether a cluster size and a minimum recording size of the non-volatile memory are different is triggered by a command to initially format the non-volatile memory.

14. A portable storage device, comprising:
a non-volatile memory to store data; and
a controller to,
determine whether a cluster size and a minimum recording size of the non-volatile memory are different,
selectively determine whether a start position of a cluster and a start position of the minimum recording size are aligned, if the cluster size and the minimum recording size are different, and
perform a formatting operation of the non-volatile memory if either the cluster size and the minimum recording size are different or the start position of the cluster and the start position of the minimum recording size are not aligned.

15. The portable storage device of claim 14, wherein the controller performs the formatting operation of the non-volatile memory by,
changing all information of a file application table (FAT) of the non-volatize memory to 0, which is an initial state; and
changing a first letter of a corresponding file name of a root directory of the FAT to a small letter sigma (σ).

16. The portable storage device of claim 14, wherein the determination of whether a cluster size and a minimum recording size of the non-volatile memory are different by the controller is triggered by a command to initially format the non-volatile memory from an external device.

17. The portable storage device of claim 14, wherein the portable storage device is a flash memory card.

18. The portable storage device of claim 14, wherein the portable storage device is a USB (universal serial bus) device.

19. The portable storage device of claim 14, wherein the non-volatile memory is NAND flash memory.
